(19) United States
(12) Patent Application Publication
(10) Pub. No.: US 2009/0016627 A1
(43) Pub. Date: Jan. 15, 2009

(54) IMAGE COMPRESSOR, IMAGE EXPANDER AND IMAGE PROCESSING APPARATUS

(75) Inventors: Yoshiharu Uetani, Kanagawa (JP); Yusuke Kikuchi, Tokyo (JP)

Correspondence Address: Gregory Turocy;Amin, Turocy & Calvin, LLP, 24th Floor, 1900 East 9th Street, Cleveland, OH, 44114, US

(73) Assignee: KABUSHIKI KAISHA TOSHIBA, Tokyo (JP)

(21) Appl. No.: 12/169,847

(22) Filed: Jul. 9, 2008

(30) Foreign Application Priority Data
Jul. 9, 2007 (JP) 2007-180181

(51) Int. Cl. G06K 9/36

(52) U.S. Cl. 382/238

(57) ABSTRACT

An image compressor has an input pixel value correction unit, a predicted pixel value generation unit, an error level detection unit, a predicted error computation unit, a predicted error coding unit, a packing unit and a target code amount difference level detection unit. The predicted error coding unit encodes, by variable-length coding, group information indicating a group to which the magnitude of a predicted error belongs and added bit data indicating a particular predicted error value in the group, and performs encoding by removing less significant bit data according to a target code amount difference level in the added bit data for the predicted error if the magnitude of the predicted error is equal to or larger than a predetermined value.

### CROSS REFERENCE TO RELATED APPLICATION

This application is based upon and claims the benefit of priority from the prior Japanese Patent Application No. 2007-180181 filed on Jul. 9, 2007; the entire contents of which are incorporated herein by reference.

### BACKGROUND OF THE INVENTION

1. Field of the Invention

The present invention relates to an image compressor, an image expander and an image processing apparatus and, more particularly, to an image compressor, an image expander and an image processing apparatus capable of controlling the amount of code by mixing reversible compression and irreversible compression on a pixel-by-pixel basis without requiring transmission of reversibility/irreversibility information (e.g. quantization scales).

2. Description of the Related Art

Conventionally, differential pulse code modulation (DPCM) in which the difference between an input value and a predicted value (referred to as a predicted difference) is encoded is used as a method of reversible coding (referred to as lossless compression or reversible compression) or irreversible coding (referred to as lossy compression or irreversible compression).

In the case of reversible compression, the amount of code varies largely image by image. In a system requiring code amount limitation, therefore, the amount of code is controlled by changing the numerical loss level (reversibility and irreversibility) with respect to a plurality of pixel regions (see, for example, Japanese Patent Publication No. 3749752).

Because of changing the numerical loss level (reversibility and irreversibility) with respect to unit regions formed of a plurality of pixels, the art disclosed in Japanese Patent Publication No. 3749752 entails the drawback of reducing the compression rate and consuming a large amount of code with respect to a large change in luminance in a portion of a small-luminance-change region (for which a compression setting is made by selecting high-restoration low-compression-rate reversible compression because of a small predicted error) due to a coding setting close to reversible compression while allowing restoration loss and deterioration in visual quality with respect to a small change in luminance in a portion of a large-luminance-change region (for which a compression setting is made by selecting high-compression-rate irreversible compression because of a large predicted error) due to a irreversible coding setting. Moreover, coding of loss level information is also required with respect to each region and a reduction in coding efficiency therefore occurs.

### SUMMARY OF THE INVENTION

According to one aspect of the present invention, there is provided an image compressor including a predicted pixel value generation unit configured to generate a predicted pixel value by referring to a past input pixel, an error level detection unit configured to detect the magnitude of the difference between the predicted pixel value and an input pixel value, a target code amount difference level detection unit configured to detect a target code amount difference level indicating the magnitude of an excess by which a generated code amount for the number of encoded pixels exceeds a target code amount corresponding to the number of pixels, an input pixel value correction unit configured to correct less significant bit data in the input pixel value according to the target code amount difference level so that the less significant bit data becomes the same as less significant bit data in the predicted pixel value when the error level is equal to or higher than a predetermined value, a predicted error computation unit configured to compute a predicted error which is the difference between a pixel value output from the input pixel value correction unit and the predicted pixel value, a predicted error coding unit configured to encode, by variable-length coding, group information indicating a group to which the magnitude of the predicted error belongs and added bit data indicating a particular predicted error value in the group, and to perform encoding by removing less significant data in the added bit data for the predicted error from an object to be encoded according to the target code amount difference level if the magnitude of the predicted error is equal to or larger than a predetermined value, and a packing unit configured to output the variable-length-coded data in a predetermined code amount unit.

According to another aspect of the present invention, there is provided an image expander including an encoded data taking-in unit configured to take in variable-length-encoded data encoded with group information indicating a group to which the magnitude of a predicted code belongs and added bit data indicating the value of the predicted error, lower significant bit data in the added bit data being removed from an object to be encoded according to the level of a difference between a target code amount and a generated code amount at the time of encoding, a target code amount difference level detection unit configured to detect a target code amount difference level indicating the magnitude of an excess by which a code amount consumed for a certain number of decoded pixels exceeds a target code amount corresponding to the number of pixels, a predicted error decoding unit configured to decode, from variable-length-encoded data output from the encoded data taking-in unit, group information indicating a group to which the magnitude of a predicted error belongs and added bit data indicating a particular predicted error value in the group, thereby reproduce the predicted error, and perform reproduction by setting less significant bit data in the added bit data for the reproduced predicted error to 0 according to the target code amount difference level when the magnitude of the predicted error is equal to or larger than a predetermined value, a predicted pixel value generation unit configured to generate a predicted pixel value by referring to a decoded pixel, and a pixel value reproduction unit configured to reproduce a pixel value by adding the reproduced predicted error to the predicted pixel value.

According to another aspect of the present invention, there is provided an image processing apparatus including an image compression processing unit having the image compressor, an image expansion processing unit having the image expander, an external memory, and an image processing unit configured to temporarily store results of intermediate processing on input image data in the external memory via the image compression processing unit, and read out a plurality of intermediate processing results stored in the external memory via the image expansion processing unit to output final results of image processing.

### BRIEF DESCRIPTION OF THE DRAWINGS

FIG. 1 is a block diagram showing an image compressor according to a first embodiment of the present invention;

FIG. 2 is a block diagram showing an example of details of the configuration shown in FIG. 1;

FIG. 3 is a diagram showing an input/output characteristic of a quantization section of a target code amount difference level detection unit;

FIG. 4 is a block diagram showing an example of a configuration of a predicted pixel value generation unit in the first embodiment;

FIG. 5 is a block diagram showing another example of details of the configuration shown in FIG. 1;

FIG. 6 is a block diagram showing an image expander according to a second embodiment of the present invention;

FIG. 7 is a block diagram showing an example of details of the configuration shown in FIG. 6;

FIG. 8 is a block diagram showing an example of a configuration of a predicted pixel value generation unit in the second embodiment;

FIG. 9 is a block diagram showing another example of details of the configuration shown in FIG. 6; and

FIG. 10 is a block diagram showing an image processing apparatus according to a third embodiment of the present invention.

### DETAILED DESCRIPTION OF THE PREFERRED EMBODIMENTS

Embodiments of the present invention will be described with reference to the accompanying drawings.

### First Embodiment

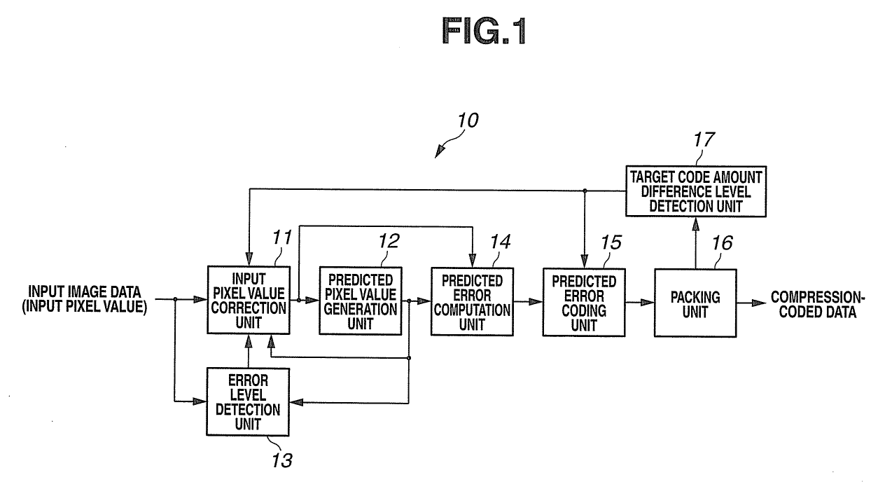

FIG. 1 is a block diagram showing an image compressor according to a first embodiment of the present invention.

The image compressor 10 shown in FIG. 1 has a predicted pixel value generation unit 12 configured to generate a predicted pixel value by referring to a past input pixel, an error level detection unit 13 configured to detect the magnitude of the difference between the predicted pixel value and an input pixel value, a target code amount difference level detection unit 17 configured to detect a target code amount difference level indicating the magnitude of an excess by which a generated code amount for the number of encoded pixels exceeds a target code amount corresponding to the number of pixels, an input pixel value correction unit 11 configured to correct less significant bit data in the input pixel value according to an error level output from the error level detection unit 13 and a target code amount difference level output from the target code amount difference level detection unit 17 so that the less significant bit data becomes the same as less significant bit data in the predicted pixel value output from the predicted pixel value generation unit 12, a predicted error computation unit 14 configured to compute a predicted error which is the difference between a pixel value output from the input pixel value correction unit 11 and the predicted pixel value output from the predicted pixel value generation unit 12, a predicted error coding unit 15 configured to encode, by variable-length coding, group information indicating a group to which the magnitude of the predicted error belongs and added bit data indicating a particular predicted error value in the group, and a packing unit 16 configured to produce a unit output corresponding to a predetermined code amount. The predicted error coding unit 15 performs encoding by removing less significant bit data in the added bit for the predicted error from the object to be encoded according to the target code amount difference level if the magnitude of the predicted error is equal to or larger than a predetermined value. More specifically, the predicted error coding unit 15 obtains variable-length encoded data as a whole by encoding the group information by variable length coding and multiplexing the added bit data on the variable length code. When the target code amount difference level is higher than 0 in the case where the magnitude of the predicted error is equal to or larger than a predetermined value, the predicted error coding unit 15 successively moves up less significant bit data in the added bit data from the least significant bit to an upper bit according to the target code amount difference level, thereby excluding the less significant bit data from the object to be encoded (object to be multiplexed). Encoding by mixing reversible compression and irreversible compression on a pixel-by-pixel basis is thus enabled.

According to the first embodiment configured as described above, an image compressor capable of controlling the amount of code by mixing reversible compression and irreversible compression on a pixel-by-pixel basis without requiring transmission of reversibility/irreversibility information can be implemented in such a manner that, in an image compressor which encodes a predicted error, an input pixel value is modified (corrected) according to a target code amount difference level when the predicted error becomes equal to or larger than a predetermined value.

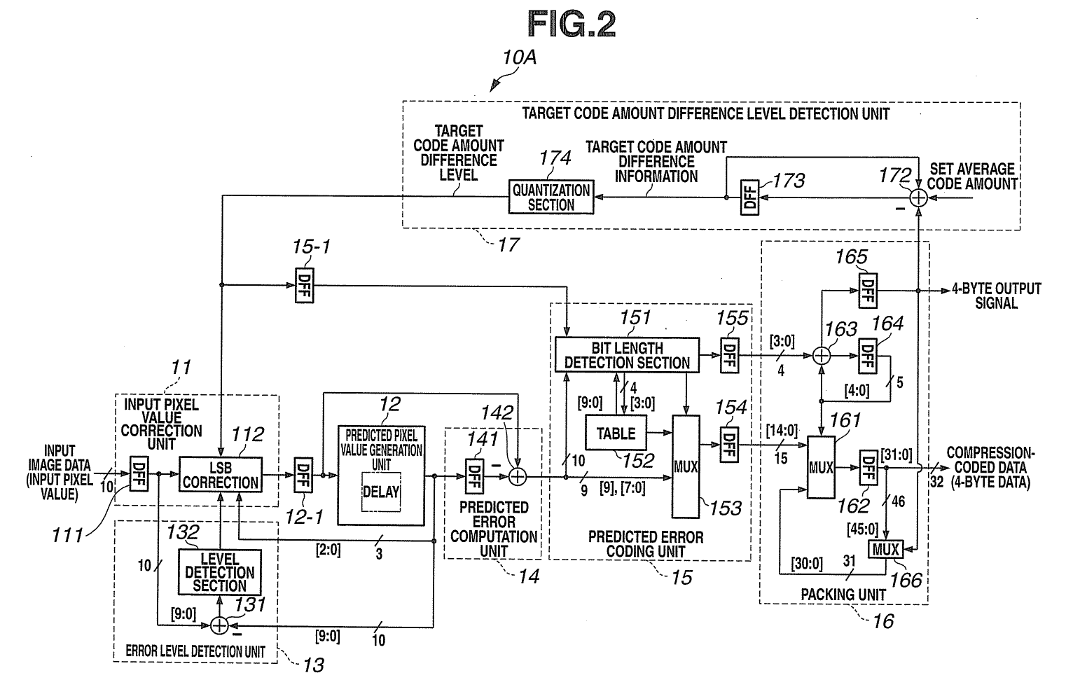

FIG. 2 is a block diagram showing an example of details of the configuration shown in FIG. 1. Units identical in function to those shown in FIG. 1 are indicated by the same reference numerals.

In an image compressor 10A shown in FIG. 2, an input pixel value correction unit 11 is supplied with data formed of a predetermined number of bits (e.g., 10 bits) in correspondence with one pixel, and has a D-flip-flop (interposed for timing of pixel data, hereinafter referred to as “DFF”) 111 provided as a one-clock-cycle delay section configured to produce a delay corresponding to one clock cycle, and an LSB (less significant bits) correction section 112 configured to correct less significant bit data in an input pixel value from the DFF 111 according to a target code amount difference level output from a target code amount difference level detection unit 17 so that the less significant bit data becomes the same as less significant bit data in a predicted pixel value from a predicted pixel value generation unit 12 only when an error level output from an error level detection unit 13 is equal to or larger than a predetermined value. However, the LSB (less significant bits) correction section 112 makes no correction to the input pixel data if the target code amount difference level is zero.

The reason for setting only less significant bit data as an object to be corrected or an object to be excluded from encoding will now be described below. More significant bits are important data, such that if an error occurs therein, the error is visually recognized as a larger error. Therefore an object to be corrected or an object to be excluded from encoding is limited within an error range in correspondence with less significant bits. The error is visually recognized easily in a small-luminance-change region. Therefore, if the magnitude of a predicted error is smaller than a predetermined value, the input pixel data is directly used without being corrected. If the magnitude of the predicted error is equal to or larger than the predetermined value, less significant bit data in the input pixel data is corrected according to the target code amount difference level so as to become the same as the predicted pixel value. That is, if the predicted error is equal to or larger than the predetermined value, the least significant bit data (the data formed of the least significant one bit) is corrected so as to become the same as the least significant bit data in the predicted pixel value. With increase in target code amount difference level, the data at the second bit position from the least significant bit and the data at the third bit position from the least significant bit are also corrected so as to become the same as the data at the corresponding bit positions in the predicted pixel value. The less significant bit data in the predicted error in the predicted error computation unit 14 can be set to zero by input pixel data correction made as described above. Encoding is performed while removing, from the object to be encoded in a predicted error coding unit 15, at the time of encoding, the less significant bit data portion of the predicted error set to zero by correcting the input pixel data as described above. That is, the data is encoded in a state where the less significant bit data zero portion of the predicted error is deleted without being encoded (in other words, the least-significant-side bit(s) in the less significant bit data is not encoded, while the other more significant bits are encoded). The encoded data is sent to the decoding side.

In a case where only one past pixel output from a DFF 12-1 which performs one-clock-cycle delay in a stage in front of the predicted pixel value generation unit 12 is referred to, the illustrated predicted pixel value generation unit 12 may be formed only of a signal line to pass the data therethrough without delaying the data. That is, the predicted pixel value generation unit 12 may be only a signal line and a signal one-clock-cycle-delayed by the DFF 12-1 (one-pixel-preceding signal) may be provided as a predicted pixel value. The arrangement may alternatively be such that, as shown in FIG. 4, the predicted pixel value generation unit 12 computes a predicted value in a computation section 122 by a predetermined function f and by referring to two past pixels represented by the signal one-clock-cycle-delayed by the DFF 12-1 in the preceding stage and a signal one-clock-cycle-delayed by a DFF 121 provided in a stage following the DFF 12-1 in series with the same (i.e., a two-pixel-preceding signal two-clock-cycle-delayed by the two DFFs 12-1 and 121). Use of a further increased number of reference pixels does not depart from the present invention.

The error level detection unit 13 has an adder 131 which takes the difference between the input pixel value from the DFF 111 and the predicted pixel value from the predicted pixel value generation unit 12, and a level detection section 132 configured to output an error level representing whether the magnitude of the difference is equal to or larger than a predetermined value.

A predicted error computation unit 14 has a DFF 141 which delays the predicted pixel data output from the predicted pixel value generation unit 12 by one clock cycle, and an adder 142 which computes the predicted error which is the difference between the input pixel value after correction processing obtained by the DFF 12-1 delaying the output from the input pixel value correction unit 111 by one clock cycle and the predicted pixel value one-clock-cycle-delayed by the DFF 141.

Table 1 shows group information (group Nos.) which is classification information indicating the magnitudes of predicted errors. Table 2 shows the relationship between added bit data corresponding to the group information indicating the magnitudes of the predicted errors and binary expressions (expressions of 2's complements) of the predicted errors. Table 3 shows an example of variable length codes in the group information indicating the magnitudes of the predicted errors and the numbers of added bits (before reducing the number of added bits). Table 4 shows an example of reductions in the numbers of added bits for the predicted error (on the less significant side).

The predicted error coding unit 15 has a bit length detection section 151 configured to detect, in correspondence with a predicted error input from the predicted error computation unit 14, predicted error group information (see Table 1) indicating a group to which the magnitude of the predicted error belongs, output the detected information to a variable length code table 152 described below, detect the number of added bits (see Table 2) related to the group information, detect a bit reduction number by which the number of added bits is to be reduced (see Table 4) according to the target code amount difference level input from the target code amount difference level detection unit 17 described below via a DFF 15-1 with respect to the predicted error group in which the magnitude of the predicted error is equal to or larger than the predetermined value, and output to a DFF 155 a total code length obtained by subtracting the bit reduction number from the sum of a variable length code length (see Table 3) received from the variable length code table 152 and the number of added bits; the variable length code table 152 configured to output to a selector (MUX) 153 described below the variable length code length and the variable length code (see Table 3) corresponding to the predicted error group information received from the bit length detection section 151, and output the variable length code length to the bit length detection section 151; and the selector (MUX) 153 configured to select the variable length code shown in Table 3 and received from the variable length code table 152 and the added bit data shown in Table 2 on the basis of the variable length code received from the variable length code table 152 and the predicted error group information received from the bit length detection section 151, and output the selected code and data as continuous data. Table 3 shows total code lengths if the target code amount difference level=0. The bit length detection section 151 of the predicted error coding unit 15 outputs a total code length reduced in the number of bits to be reduced shown in Table 4 from the original length (Table 3) according to the target code amount difference level from the target code amount difference level detection unit 17 in a case where the magnitude of the predicted error belongs to one of the group of predicted errors equal to or larger than the predetermined value. As a result, encoding is performed while treating as invalid the less significant bit data corresponding to the bit reduction number in the added bit data for the predicted error and excluding the less significant bit data from the object to be encoded.

A packing unit 16 has an adder 163 which adds together the total code length (4-bit data) input from the bit length detection section 151 via the DFF 155 and 5-bit data obtained by cumulatively adding this input total code length data and the past total code length data held in a DFF 164 each time one pixel is encoded (each clock cycle), outputs the less significant 5-bit data in the result of this addition to the DFF 164, and outputs a one-bit signal indicating the match between the addition result and a value equal to or larger than 32 (=4 bytes) as a 4-byte output signal to a DFF 165 when the addition result reaches this value; a selector (MUX) 161 which combines, according to the addition result from the DFF 164, the encoded data (output data from the selector 153) input via the DFF 154 with combined encoded data less than 32 bits obtained by combining past encoded data output from a selector (MUX) 166 so that the encoded data from the DFF 154 follows the past data, and outputs the combined data as new combined encoded data; a DFF 162 which delays the combined encoded data output from the MUX 161 by one clock cycle and outputs the delayed data; and the selector (MUX) 166 which, if the number of valid bits in the combined encoded data from the DFF 162 is 31 or less, outputs combined encoded data formed of more significant 31 bits from the DFF 162 on the basis of a 4-byte output signal from the DFF 165, and which, if the number of valid bits in the combined encoded data from the DFF 162 is 32 or more, outputs combined encoded data formed of less significant bits other than the more significant 32 bits from the DFF 162 (the number of valid bits in these less significant bits being 14 or less) and invalid data (which may have any value and may be zero). The packing unit 16 outputs the above-described combined encoded data in a predetermined code amount unit (e.g., a 4-byte unit) together with a predetermined unit output signal (e.g., a 4-byte output signal) and outputs information on the number of output bytes (e.g., a 4-byte output signal) to the target code amount difference level detection unit 17.

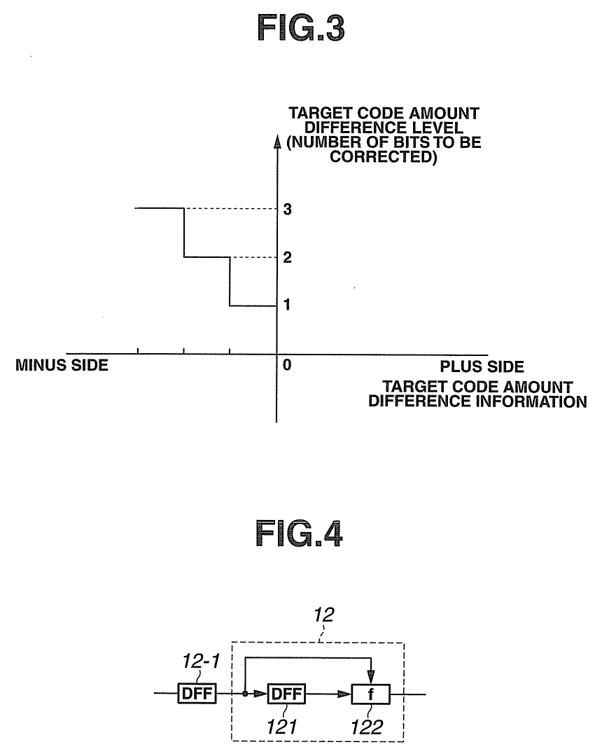

The target code amount difference level detection unit 17 has an adder 172 which adds together a set average code amount (e.g., a code amount of 8 bits per pixel) set in a control unit (not shown) and target code amount difference information (code amount difference cumulative addition result) held in a DFF 173 one clock cycle before, subtracts the number of output bits (e.g., 32) from the addition result when the information on the number of output byte (4-byte output signal) from the packing unit 16 is valid, and outputs the code amount difference cumulative addition result as target code amount difference information via the DFF 173, and a quantization section 174 which is supplied with the target code amount difference information output from the DFF 173 and performs quantization according to the target code amount difference information (see FIG. 3) to output a target code amount difference level. That is, the target code amount difference level detection unit 17 computes the target code amount difference information as “(a target code amount obtained by cumulative addition of the number of set average code amounts corresponding to the number of encoded pixels)−(the output code amount output with respect to the number of encoded pixels)” to detect a target code amount difference level representing the magnitude of an excess by which the generated code amount (output code amount) corresponding to the number of encoded pixels exceeds the target code amount corresponding to the number of pixels.

In the notation in FIG. 2, 10-bit data from the 0th bit to 9th bit is expressed as [9:0]. Also, [9] represents the code bit existing as the most significant bit in the 10-bit data.

FIG. 3 shows an input/output characteristic (quantization characteristic) of the quantization section 174 of the target code amount difference level detection unit 17. That is, FIG. 3 shows target code amount difference levels discretely output with respect to target code amount difference information input to the quantization section 174. In the present embodiment, this difference level corresponds to “the number of bits to be corrected”. However, any linear correspondence is not required therebetween. For example, the number of bits to be corrected with respect to the target code amount difference level 3 may be 4. The characteristic is such that, as shown in FIG. 3, when the target code amount difference information is positive (that is, the output code amount from the packing unit does not exceed the target code amount), the target code amount difference level is zero, and, when the target code amount difference information is negative (that is, the output code amount from the packing unit exceeds the target code amount), the target code amount difference level increases to 1, 2, 3, . . . according to the magnitude on the negative side.

Thus, reversible compression is performed in the target code amount difference information positive region, even when the magnitude of the predicted error is equal to or larger than the predetermined value, and irreversible compression is performed only when both the condition that the magnitude of the predicted error is equal to or larger than the predetermined value and the condition that target code amount difference information is in the negative region are satisfied.

The operation of the image compressor according to the first embodiment of the present invention will be described with reference to FIGS. 1 to 4.

The target code amount difference level detection unit 17 shown in FIG. 1 detects a target code amount difference level indicating the magnitude of an excess by which a generated code amount for the number of encoded pixels exceeds a target code amount corresponding to the number of pixels (=a set average code amount×the number of pixels). More specifically, the target code amount difference level detection unit 17 performs cumulative addition of a set average code amount in each clock cycle, subtracts from the target code amount (the cumulative addition result) an output code amount (number of output bytes) from the packing unit 16 each time encoded data of a predetermined number of bytes (e.g., 4 bytes) is output from the packing unit 16, and detects the level of the subtraction result as a target code amount difference level when the subtraction result is negative, as does the target code amount difference level detection unit 17 shown in FIG. 2. That is, the target code amount difference level detection unit 17 has a value of a target code amount difference level >0 according to the level of the subtraction result when the subtraction result is negative.

When input of image data is started, the target code amount difference information is positive and the target code amount difference level output from the quantization section 174 shown in FIG. 2 is 0 according to the input/output characteristic of the quantization section 174 (see FIG. 3), because the number of bytes output from the packing unit 16 shown in FIG. 2 to the adder 172 is 0 at all times. At the time of starting image data input, since the target code amount difference level is 0, the pixel data input to the input pixel value correction unit 11 is output to the predicted pixel value generation unit 12 and to the predicted error computation unit 14 without being corrected (regardless of the error level from the error level detection unit 13).

In the predicted error computation unit 14 shown in FIG. 1, a predicted error is computed by taking the difference between the present input pixel value (the output from DFF 12-1) and the predicted pixel value (the output from DFF 141) generated by referring to past input pixels in the predicted pixel value generation unit 12.

The predicted error coding unit 15 shown in FIG. 1 detects group information (group No.) indicating the magnitude of a predicted error such as shown in Table 1 and obtains encoded data by multiplexing added bit data, such as shown in Table 2, for the predicted error related to the group information on a variable length code for the group information, such as shown in Table 3. If the target code amount difference level is 0, none of the added bits is removed no matter what the group information (the magnitude of the predicted error).

The packing unit 16 shown in FIG. 1 is, in its concrete form, configured like the packing unit 16 shown in FIG. 2 to successively connect and hold input encoded data, output more significant 4-byte data in the held encoded data out of the image compressor each time the bit length of the held encoded data becomes equal to or larger than 32 (i.e., 4 bytes), remove the output 4-byte data from the held encoded data, outputs information on the number of the output bytes to the target code amount difference level detection unit 17. Therefore, before the amount of held encoded data reaches 4 bytes or more, information on the number of the output bytes is output as zero to the target code amount difference level detection unit 17.

Encoding is continued in this way. When the target code amount difference level becomes equal to or higher than 1, the error level detection unit 13 shown in FIG. 1, detecting the magnitude of the difference between the input pixel value and the predicted pixel value at all times, controls the input pixel value correction unit 11 if the difference is equal to or higher than a predetermined level (e.g., equal to or lower than −65 or equal to or higher than 64, i.e., corresponding to group Nos. 7 to 9 as shown in Table 1), thereby correcting the number of bits (see Table 4) of less significant bit data in the input pixel value according to the target code amount difference level (the number of bits to be corrected) to the same value as the less significant bit data in the predicted pixel value. In the predicted error computed in the predicted error computation unit 14 in this case, the less significant bit data having the number of bits according to the target code amount difference level is 0. Accordingly, in the predicted error coding unit 15 having added bit data such as shown in Table 2 multiplexed on the variable length code in the group information indicating the magnitude of the predicted error as shown in Table 3, encoding is performed by removing the number of less significant bits according to the target code amount difference level (0, 1, 2, 3) from the object to be encoded (object to be multiplexed), as shown in Table 4. However, if the target code amount difference level=0, the bit reduction number by which the added bits for the predicted error is to be reduced is zero and none of the added bits is excluded from the object to be encoded (object to be multiplexed).

Table 1 shows group Nos. indicating the ranges of the magnitudes of predicted errors. Table 2 shows the relationship between added bit data and binary expressions (expressions of 2's complements) of the predicted errors for the group information (group Nos.). In Table 2, binary expressions are made by using character variables and an expression to represent a code bit is made by using “S”. In a predicted error binary expression column, data expressed in 2's complement form is shown, in which S represents a plus/minus sign, N represents a bit data defined by bit-inverting the plus/minus sign, and abcdefhg is bit data specifying values in the group in combination with the plus/minus sign. In an added bit data column, S represents one bit of a plus/minus sign and each character in abcdefgh represents data at the corresponding bit position in the binary expression of the predicted error. Table 3 shows a list of variable length codes corresponding to the group Nos., variable length code lengths, numbers of added bits (before reducing the number of added bits according to the target code amount error level) and a list of total code lengths for the predicted errors. At the time of encoding of the given predicted error, the variable length code and added bits corresponding to the group information (group No.) for the predicted error are serially multiplexed to be output as variable length coded data.

Target code amount difference levels 0, 1, 2, and 3 in Table 4 represent steps of the magnitudes of the above-mentioned target code amount difference levels and correspond to the number of bits to be corrected (the number of less significant bits) shown as the target code amount difference level on the ordinate of FIG. 3. Table 4 shows an example of bit reduction numbers for reduction of the added bit data for the predicted errors. The number of added bits in the groups Nos. 7 to 9 (i.e., those having magnitudes of predicted errors equal to or smaller than −65 or equal to or larger than 64) is reduced by “1”, “2” or “3” according to the target code amount difference level (in other words, one to three bits of less significant bits in the added bits are removed from the object to be encoded). While in the above-described example, one bit, two bits or three bits from the least significant bit in the less significant bit data are removed in correspondence with steps 1, 2, and 3 of the magnitudes of the target code amount difference level, the arrangement may alternatively be such that, for example, one bit, two bits or four bits from the least significant bit in the less significant bit data are removed in correspondence with steps 1, 2, and 3 of the magnitudes of the target code amount difference level. In other words, in the predicted error coding unit 15, encoding is performed by removing from the object to be encoded a suitable number of bits of less significant bit data in the added bit data for the predicted error according to the target code amount difference level, for example, as shown in Table 4 (encoding is performed by removing a suitable number of bits from the least significant bit to the more significant side).

TABLE 1

| | |
|---|---|
| Predicted error | Group No. |

| | | |
|---|---|---|
| −1 | 0 | 0 |
| −2 | 1 | 1 |
| −4-−3 | 2-3 | 2 |
| −8-−5 | 4-7 | 3 |
| −16-−9 | 8-15 | 4 |
| −32-−17 | 16-31 | 5 |
| −64-−33 | 32-63 | 6 |
| −128-−65 | 64-127 | 7 |
| −256-−129 | 128-255 | 8 |
| −512-−257 | 256-511 | 9 |

TABLE 2

| | Binary expression of | | |
|---|---|---|---|
| Group No. | predicted error | Number of added bits | Added bit data |
| 0 | SS SSSS SSSS | 1 | S |
| 1 | SS SSSS SSSN | 1 | S |
| 2 | SS SSSS SSNh | 2 | Sh |
| 3 | SS SSSS SNgh | 3 | Sgh |
| 4 | SS SSSS Nfgh | 4 | Sfgh |
| 5 | SS SSSN efgh | 5 | Sefgh |
| 6 | SS SSNd efgh | 6 | Sdefgh |
| 7 | SS SNcd efgh | 7 | Scdefgh |
| 8 | SS Nbcd efgh | 8 | Sbcdefgh |
| 9 | SN abcd efgh | 9 | Sabcdefgh |

S is a plus/minus sign bit, and N is a bit inversion of S.

TABLE 3

| Group | Variable length | Variable length | Number of | Total code |
|---|---|---|---|---|
| No. | code | code length | added bits | length |
| 0 | 11100 | 5 | 1 | 6 |
| 1 | 11101 | 5 | 1 | 6 |
| 2 | 1100 | 4 | 2 | 6 |
| 3 | 100 | 3 | 3 | 6 |
| 4 | 00 | 2 | 4 | 6 |
| 5 | 01 | 2 | 5 | 7 |
| 6 | 101 | 3 | 6 | 9 |
| 7 | 1101 | 4 | 7 | 11 |
| 8 | 11110 | 5 | 8 | 13 |
| 9 | 11111 | 5 | 9 | 14 |

TABLE 4

Target code amount difference level

| Group No. | 0 | 1 | 2 | 3 |
|---|---|---|---|---|
| 0 | 0 | 0 | 0 | 0 |
| 1 | 0 | 0 | 0 | 0 |
| 2 | 0 | 0 | 0 | 0 |
| 3 | 0 | 0 | 0 | 0 |
| 4 | 0 | 0 | 0 | 0 |
| 5 | 0 | 0 | 0 | 0 |
| 6 | 0 | 0 | 0 | 0 |
| 7 | 0 | 1 | 2 | 3 |
| 8 | 0 | 1 | 2 | 3 |
| 9 | 0 | 1 | 2 | 3 |

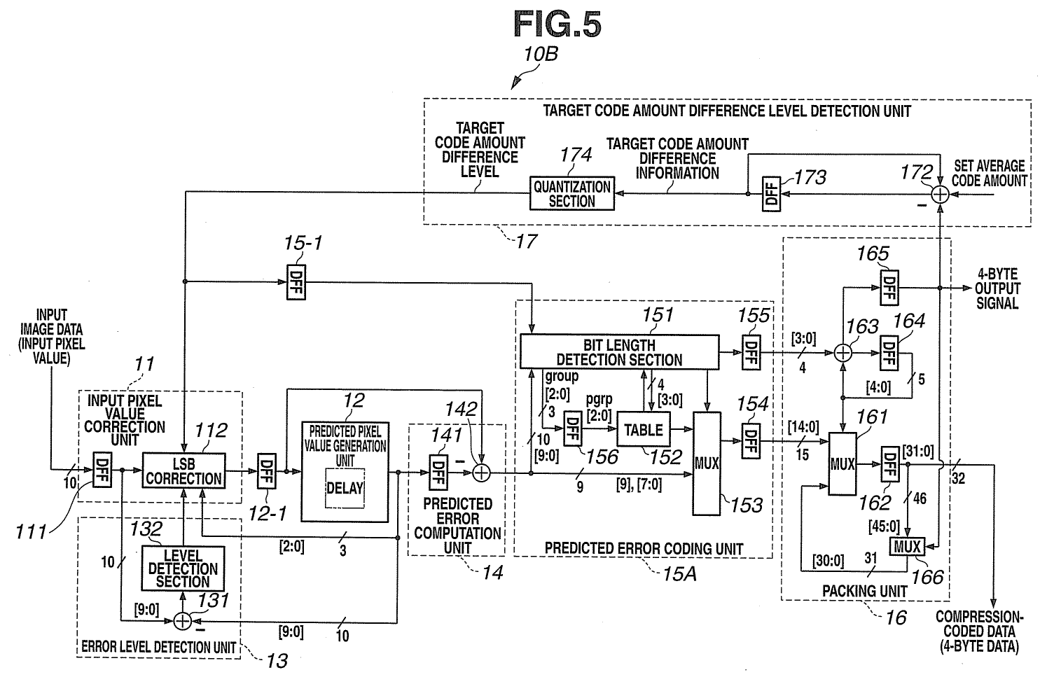

FIG. 5 is a block diagram showing another example of details of the configuration shown in FIG. 1. Units or sections identical in function to those shown in FIGS. 1 and 2 are indicated by the same reference numerals. The example of the configuration shown in FIG. 5 is arranged to further improve the coding efficiency by referring to the value of group information PGRP for a predicted error one pixel before and changing a variable length code in group information (group No.) for a predicted error of the present pixel according to the group information PGRP.

Table 5 shows an example of group information PGRP for a predicted error one pixel before. Table 6 shows an example of variable length codes in group information each representing the magnitude of a predicted error at the time of code table change. Table 7 shows a total code length at the time of code table change in Table 6 (before reducing added bits).

In contrast with the above-described example of the configuration shown in FIG. 2, an image compressor 10B shown in FIG. 5 has a DFF 156 provided in a predicted error coding unit 15A as a storage section in which group information PGRP (see Table 5) on the magnitude of a predicted error one pixel before is stored. A variable length code in group information (group No.) indicating a group to which the magnitude of a predicted error belongs is changed according to the value of group information PGRP for a predicted error one pixel before, as shown in Table 6. The coding efficiency can be further improved in this way. In Table 5, the ranges of the magnitudes of predicted errors one pixel before are grouped into six ranges 0 to 5 and group information PGRP on the groups of the predicted errors can be expressed in 3-bit form (pgrp[2:0]).

As the variable length coding table 152 in the example of the configuration shown in FIG. 5, the variable length code table shown as Table 6 and the total code length table shown as Table 7 are used. In this example, the total code length before reducing added bits is determined according to the predicted error group No. and group information PGRP for a predicted error one pixel before, as shown in Table 7, and the bit reduction number shown in Table 4 is subtracted from the total code length according to the target code amount difference level. That is, less significant bits in added bit data for a predicted error corresponding to the bit reduction number are removed from the object to be encoded according to the target code amount difference level.

TABLE 5

| | |
|---|---|
| Predicted error | PGRP |

| | | |
|---|---|---|
| −1 | 0 | 0 |
| −2 | 1 | 0 |
| −4-−3 | 2-3 | 0 |
| −8-−5 | 4-7 | 0 |
| −16-−9 | 8-15 | 1 |
| −32-−17 | 16-31 | 2 |
| −64-−33 | 32-63 | 3 |
| −128-−65 | 64-127 | 4 |
| −256-−129 | 128-255 | 5 |
| −512-−257 | 256-511 | 5 |

TABLE 6

| Group | PGRP for predicted error one pixel before | | | | | |
|---|---|---|---|---|---|---|
| No. | 0 | 1 | 2 | 3 | 4 | 5 |
| 0 | 1100 | 1100 | 11100 | 11100 | 111110 | 1111110 |
| 1 | 1101 | 11110 | 11101 | 11101 | 111111 | 1111111 |
| 2 | 1110 | 1101 | 1100 | 11110 | 11110 | 111110 |
| 3 | 100 | 100 | 100 | 1100 | 1100 | 11110 |
| 4 | 00 | 00 | 00 | 100 | 1101 | 1110 |
| 5 | 01 | 01 | 01 | 00 | 100 | 100 |
| 6 | 101 | 101 | 101 | 01 | 00 | 101 |
| 7 | 11110 | 1110 | 1101 | 101 | 01 | 110 |
| 8 | 111110 | 111110 | 11110 | 1101 | 101 | 00 |
| 9 | 111111 | 111111 | 11111 | 11111 | 1110 | 01 |

TABLE 7

| | |
|---|---|
| Group | PGRP for predicted error one pixel before |

| No. | 0 | 1 | 2 | 3 | 4 | 5 |
|---|---|---|---|---|---|---|
| 0 | 5 | 5 | 6 | 6 | 7 | 8 |
| 1 | 5 | 6 | 6 | 6 | 7 | 8 |
| 2 | 6 | 6 | 6 | 7 | 7 | 8 |
| 3 | 6 | 6 | 6 | 7 | 7 | 8 |
| 4 | 6 | 6 | 6 | 7 | 8 | 8 |
| 5 | 7 | 7 | 7 | 7 | 8 | 8 |
| 6 | 9 | 9 | 9 | 8 | 8 | 9 |
| 7 | 12 | 11 | 11 | 10 | 9 | 10 |
| 8 | 14 | 14 | 13 | 12 | 11 | 10 |
| 9 | 15 | 15 | 14 | 14 | 13 | 11 |

The error level detection unit 13 and the predicted error computation unit 14 use only less significant bit data having the same number of bits as the number of input bits and detect an error level and a predicted error while ignoring code overflow to more significant bits (called degeneration in some case). Therefore, the dynamic range of differential data is not increased, reproduction to the same value as the pixel value data output from the input pixel value correction unit 11 can be performed, and the compression efficiency can also be improved.

Decoding reproduction on the decoding side will be described in the following description of a second embodiment of the present invention.

According to the first embodiment, a case where irreversible compression occurs (for example, a case where the target code amount difference information shown in FIG. 3 is on the negative side and where the magnitude of a predicted error is equal to or larger than a predetermined value) is limited to a case where the magnitude of a predicted error is equal to or larger than a predetermined value, that is, a pixel with a large change in luminance is generated. Therefore, code amount control can be performed without causing any deterioration in visual image quality.

Also, a storage section in which group information for the magnitude of a predicted error one pixel before is stored is provided and a variable length code in group information indicating the group to which the magnitude of the predicted error belongs is changed according to the magnitude of the predicted error one pixel before, thereby further improving the coding efficiency.

### Second Embodiment

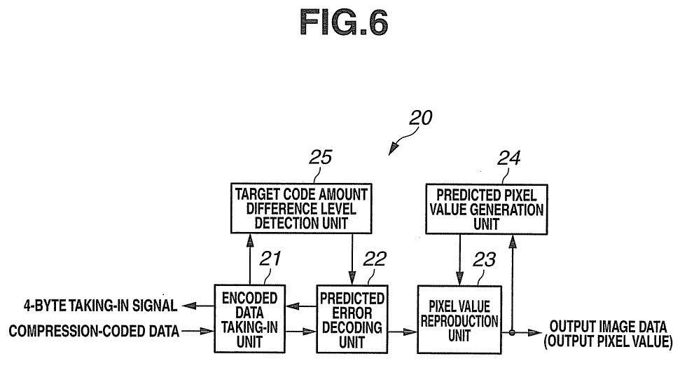

FIG. 6 is a block diagram showing an image expander according to a second embodiment of the present invention.

The image expander 20 shown in FIG. 6 has an encoded data taking-in unit 21 configured to take in encoded data from the image compressor according to the first embodiment, a target code amount difference level detection unit 25 configured to detect a target code amount difference level indicating the magnitude of an excess by which a code amount consumed for a certain number of decoded pixels exceeds a target code amount corresponding to the number of pixels, a predicted error decoding unit 22 configured to decode, from variable length code data output from the encoded data taking-in unit 21, group information indicating a group to which the magnitude of a predicted error belongs and added bit data indicating a particular predicted error value in the group, thereby reproduce the predicted error, and detect a code length, a predicted pixel value generation unit 24 configured to generate a predicted pixel value by referring to a past reproduced pixel, and a pixel value reproduction unit 23 configured to reproduce a pixel value by adding the reproduced predicted error to the predicted pixel value. In a case where the magnitude of the predicted error is equal to or larger than a predetermined value, the predicted error decoding unit 22 reproduces less significant bit data in the added bit data for the reproduced predicted error as 0 according to a target code amount difference level. That is, reproducing is performed by assigning 0 to the less significant bit data portion deleted on the encoding side.

According to the second embodiment thus configured, in an image expander configured to decode a predicted error encoded as in the first embodiment, the predicted error is reproduced by setting less significant bit data in added bit data for the reproduced predicted error to 0 according to a target code amount difference level if the predicted error exceeds a predetermined value, thus implementing an image expander not requiring transmission of information on reversibility/irreversibility on a pixel by pixel basis at the time of encoding with respect to encoded data code-amount-controlled by mixing reversible compression and irreversible compression on a pixel-by-pixel basis.

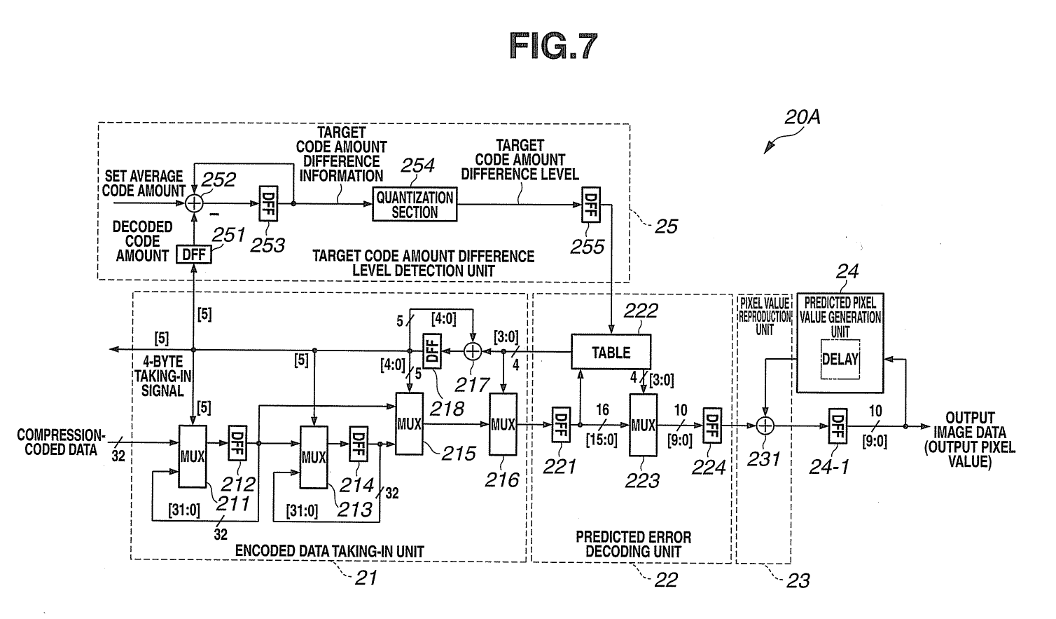

FIG. 7 is a block diagram showing an example of details of the configuration shown in FIG. 6. Units identical in function to those shown in FIG. 6 are indicated by the same reference numerals.

In an image expander 20A shown in FIG. 7, a compression-coded data (4-byte data) is input to the encoded data taking-in unit 21, and data is successively taken in a DFF 212 and a DFF 214 via a selector (MUX) 211 and a selector (MUX) 213 at each clock cycle in a time period when a 4-byte taking-in signal is valid and is, after being taken in the DFF 212 and DFF 214, held via the MUX 211 and MUX 213 in a time period when the 4-byte taking-in signal is invalid. That is, the 4-byte taking-in signal is made valid for a two-clock-cycle period for taking in initial data by a control circuit (not shown) and is thereafter made valid for a one-clock-cycle period each time the sum of the numbers of decoded bits becomes equal to 32 bits (4 bytes) or more. A selector (MUX) 215 cues at a one-pixel preceding stage, as one continuous sequence of data, a variable length code in the encoded data thus held in the DFF 212 and DFF 214 on the basis of information less than 32 bits in the result of cumulative addition of the number of bits of the variable length code decoded till the time two pixel before. A selector (MUX) 216 is supplied with data output from this selector (MUX) 215 and cues a variable length code of a next decoded pixel on the basis of the number of bits (the code length) of encoded data one pixel before from a variable length code decoding table 222. An adder 217 adds together code length data supplied from the variable length code decoding table 222 and less significant five bits in the cumulative addition result one clock cycle before held by a DFF 218 to output data formed of six bits including a carry bit to the DFF 218. That is, data [5] formed of the most significant bit (6th bit) output from the DFF 218 becomes valid each time the result of cumulative addition of the number of bits of a variable length code decoded till the time two pixel before reaches 32 bits (=4 bytes). This data becomes the above-mentioned 4-byte taking-in signal. This signal is one-clock-cycle-delayed by a DFF 251 to be supplied to minus input end of an adder 252 in the target code amount difference level detection unit 25. The less significant five-bit data output from DFF 218 is also used for variable length code cueing by the selector (MUX) 215 as information less than 32 bits in the result of cumulative addition of the number of bits of a variable length code decoded till the time two pixel before.

The predicted error decoding unit 22 has a DFF 221 configured to delay, by one clock cycle, variable-length-encoded data output from the encoded data taking-in unit 21, the decoding table 222 (see Tables 3 and 4) which is supplied with variable-length-encoded data from the DFF 221, and which decodes group information indicating a group to which the magnitude of a predicted error belongs and the code length thereof, reproduces the number of added bits for indicating a particular predicted error value in the group on the basis of the group information, reproduces, on basis of the group information, a bit reduction number by which the number of added bits is to be reduced according to the target code amount difference level detected in the target code amount difference level detection unit 25, if the predicted error is equal to or larger than a predetermined value, and generates a total number of bits (code length) as a result of subtraction of the bit reduction number from the sum of the code length of the group information and the number of added bits, and a selector (MUX) 223 which performs code expansion processing on the basis of the code length of the group information (group No.) obtained as a result of decoding with the decoding table 222 in output data from the DFF 221, by removing the encoded data in the group information (group No.) and extracting the added bit data having the number of added bits (see Table 2), substitutes zero for less significant bit data for the bit reduction number in the added bit data (see Table 4 with respect to a condition for substitution of zero and the number of bits), and outputs the resulting data.

The target code amount difference level detection unit 25 has the DFF 251 to which the 4-byte taking-in signal generated in the encoded data taking-in unit 21 is input by a control section (not shown) during a time period other than a two-clock-cycle period for taking in initial data, delays the signal by one clock cycle, and supplies the signal as a 4-byte decoded code amount to minus input end of the adder 252, the adder 252 which is supplied through its one input terminal with a set average code amount (e.g., a code amount of 8 bits per pixel) set by the control section (not shown), and which adds the input set average code amount to the cumulative addition result one clock cycle before held by a DFF 253, subtracts a code amount of 32 bits (4 bytes) from the result of cumulative addition of the set average code amount each time one-bit signal indicating the 4-byte form is input from the DFF 251, and outputs the result of this subtraction as target code amount difference information via the DFF 253, and a quantization section 254 which is supplied with the target code amount difference information output from the DFF 253, and which performs the same predetermined quantization as that on the encoder side on the target code amount difference information (see FIG. 3) and outputs the result of quantization as a target code amount difference level. That is, the target code amount difference level detection unit 25 subtracts the number of bytes additionally taken in from the cumulative addition result successively obtained as a target code amount (not performing subtraction with respect to the number of bytes at the time of taking in initial data, because the same initial condition as that on the encoding side is set), and detects the level of the subtraction result as the target code amount difference level when the subtraction result is negative.

The pixel value reproduction unit 23 has an adder 231 which adds the predicted error reproduced in the predicted error decoding unit 22 to a predicted pixel value from the predicted pixel value generation unit 24 to reproduce a pixel value.

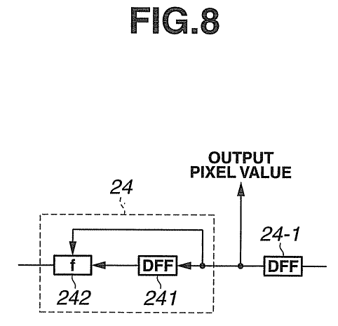

The predicted pixel value generation unit 24 generates a predicted pixel value by referring to a past reproduced pixel which is input thereto by one-clock-cycle-delaying by means of a DFF 24-1 a pixel value reproduced by the pixel value reproduction unit 23. The predicted pixel value generation unit 24 may be configured, for example, to directly pass therethrough the output from the DFF 24-1 in the preceding stage that produces a one-clock-cycle delay, while only referring to this output. (That is, the predicted pixel value generation unit 24 may be configured to use the one-clock-cycle-delayed signal from the DFF 24-1 as a predicted pixel value by means of a signal line only.) The predicted pixel value generation unit 24 may alternatively be configured as shown in FIG. 8 to generate a predicted pixel value by performing computation by a predetermined function f in a computation section 242 using a signal one-clock-cycle-delayed by the DFF 24-1 and a signal obtained by further one-clock-cycle-delaying the one-clock-cycle-delayed signal through another DFF 241 (i.e., a signal two-clock-cycle-delayed by two DFFs 24-1 and 241). The number of reference pixels may be increased. However, the number of reference pixels and the function f may be set as the same as those on the encoder side.

The operation of the image expander according to the second embodiment of the present invention will be described with reference to FIGS. 6 to 8.

The encoded data taking-in unit 21 takes in encoded data in a predetermined byte unit from the image compressor according to the code length of decoded pixels from the predicted error decoding unit 22, and supplies data including the result of cueing of data on the next pixel to the predicted error decoding unit 22. The target code amount difference level detection unit 25, if provided in a concrete form as represented by the target code amount difference level detection unit 25 shown in FIG. 7, performs cumulative addition of a set average code amount in each clock cycle, subtracts a predetermined number of bytes additionally taken in and output as a code amount from the encoded data taking-in unit 21 from the cumulative addition result obtained as its target code amount each time additional data having the predetermined number of bytes is taken in the encoded data taking-in unit 21 (not performing subtraction with respect to the number of bytes of data initially taken in), and outputs the level of the subtraction result as a target code amount difference level when the subtraction result is negative. The predicted error decoding unit 22 reproduces group information (group No.) indicating a group to which a predicted error belongs from variable length encoded data output from the encoded data taking-in unit 21 on the basis of Table 3 implemented as the variable length code decoding table 222, and reproduces the original predicted error from added bit data indicating a particular predicted error value in each group on the basis of Table 2. At this time, if the group information is equal to or higher than a predetermined level (e.g., equal to or lower than −65 or equal to or higher than 64, that is, corresponding to groups Nos. 7 to 9), the table 222 substitutes 0 for less significant bits in the added bit data for the reproduced predicted error on the basis of Table 4 according to the target code amount difference level detected by the target code amount difference level detection unit 25. Thus, reproduction can be performed without requiring transmission of reversibility/irreversibility information on a pixel-by-pixel basis at the time of encoding.

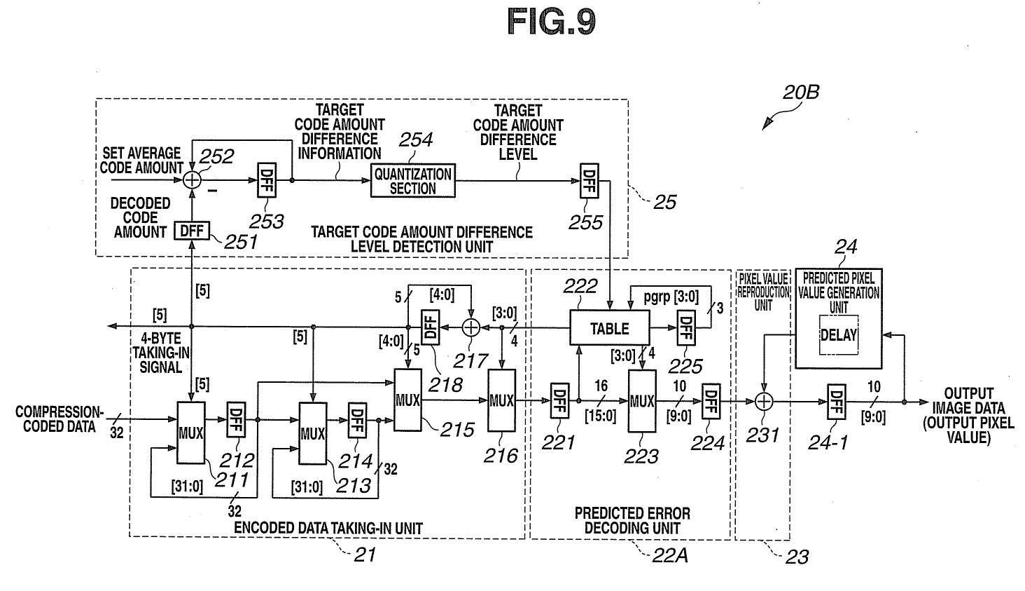

FIG. 9 is a block diagram showing another example of details of the configuration shown in FIG. 6. Units or sections identical in function to those shown in FIGS. 6 and 7 are indicated by the same reference numerals.

In contrast with the above-described example of the configuration shown in FIG. 7, an image expander 20B shown in FIG. 9 has, as in a predicted error decoding unit 22A shown in FIG. 9, a DFF 225 provided as a storage section in which group information PGRP (see Table 5) for a predicted error one pixel before is stored. A variable length code in group information (group No.) indicating a group to which the magnitude of a predicted error belongs is changed according to group information PGRP for a predicted error one pixel before, as shown in Table 6, thus enabling decoding without requiring any code table change information from the encoding side. Table 2 and Tables 4 to 7 are used as the variable length code decoding table 222 shown in FIG. 9.

Also in the second embodiment, Tables 2, 3, and 6 described in the description of the first embodiment are used. However, these tables are used in a reverse direction in expansion processing in the second embodiment with respect to the correspondence between group information and variable length codes (Tables 3 and 6) and the correspondence between the binary expressions of predicted errors and the added bit data (Table 2) in comparison with compression processing in the first embodiment.

According to the second embodiment, reproducing is performed by substituting 0 for less significant bit data in added bit data corresponding to the number of bits deleted on the encoding side on the basis of a target code amount difference level computable at the time of decoding and group information indicating a group to which the magnitude of an encoded predicted error belongs, and added bits indicating a particular predicted error value in each group is decoded to reproduce the predicted error. Therefore, any reversibility/irreversibility information on a pixel-by-pixel basis at the time of encoding is not required.

Also, a storage section for storing a predicted error one pixel before is provided and a variable length code in group information indicating a group to which the magnitude of a predicted error belongs is changed according to a predicted error one pixel before. In this way, decoding without requiring any code table change information from the encoding side is enabled.

### Third Embodiment

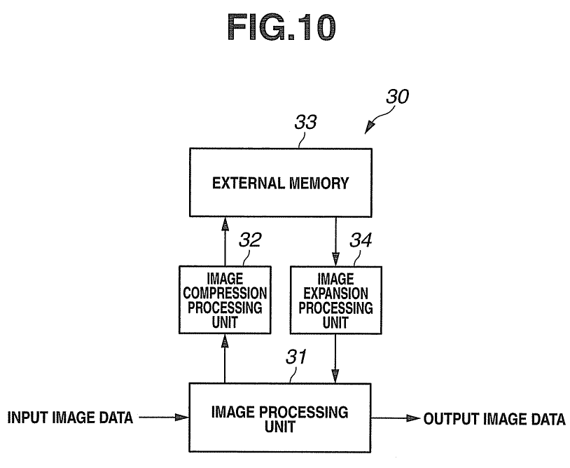

FIG. 10 is a block diagram showing an image processing apparatus according to a third embodiment of the present invention.

The image processing apparatus 30 shown in FIG. 10 has an image compression processing unit 32 including the image compressor shown in FIGS. 1 and 2 or 5, an image expansion processing unit 34 including the image expander shown in FIGS. 6 and 7 or 9, an external memory 33, and an image processing unit 31. The image processing unit 31 temporarily stores, results of intermediate processing on input image data in the external memory 33 via the image compression processing unit 32, and reads out a plurality of intermediate processing results stored in the external memory 33 via the image expansion processing unit 34 to output final results of image processing.

According to the third embodiment, a case where irreversible compression occurs is limited to a case where the magnitude of a predicted error is equal to or larger than a predetermined value, that is, a pixel with a large change in luminance is generated, and where the target code amount difference level is 1 or higher (e.g., a case where comparatively large changes in luminance occur successively close to each other, and where the target code amount difference information shown in FIG. 3 is on the negative side). Therefore, such a loss in pixel value does not badly affect the visual quality, and it is possible to obtain high-quality image processing results by limiting the external memory capacity and the memory bandwidth.

Having described the embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An image compressor comprising:
a predicted pixel value generation unit configured to generate a predicted pixel value by referring to a past input pixel;
an error level detection unit configured to detect an error level indicating the magnitude of a difference between the predicted pixel value and an input pixel value;
a target code amount difference level detection unit configured to detect a target code amount difference level indicating the magnitude of an excess by which a generated code amount for a certain number of encoded pixels exceeds a target code amount corresponding to the number of pixels;
an input pixel value correction unit configured to correct less significant bit data in the input pixel value according to the target code amount difference level so that the less significant bit data becomes the same as less significant bit data in the predicted pixel value when the error level is equal to or higher than a predetermined value;
a predicted error computation unit configured to compute a predicted error which is a difference between a pixel value output from the input pixel value correction unit and the predicted pixel value;
a predicted error coding unit configured to encode, by variable-length coding, group information indicating a group to which the magnitude of the predicted error belongs and added bit data indicating a particular predicted error value in the group, and to perform encoding by removing less significant data in the added bit data for the predicted error from an object to be encoded according to the target code amount difference level if the magnitude of the predicted error is equal to or larger than a predetermined value; and
a packing unit configured to output the variable-length-coded data in a predetermined code amount unit.

2. The image compressor according to claim 1, wherein the predicted error coding unit has a one-pixel-preceding predicted error group information storage section in which one-pixel-preceding predicted error group information indicating a group to which the magnitude of a predicted error one pixel before belongs is stored, and changes, according to the one-pixel-preceding predicted error group information, a variable length code table containing the group information indicating the groups to which the magnitudes of the predicted errors belong.

3. The image compressor according to claim 1, wherein
the error level detection unit includes:
an adder configured to take a difference between an input pixel value and a predicted pixel value from the predicted pixel value generation unit; and
a level detection section configured to output an error level according to the difference from the adder, and
the input pixel value correction unit has an LSB (less significant bits) correction section configured to correct less significant bit data in an input pixel value according to a combination of the error level output from the error level detection unit and the target code amount difference level (target code amount difference level >0) output from the target code amount difference level detection unit so that the less significant bit data becomes the same as less significant bit data in the predicted pixel value from the predicted pixel value generation unit.

4. The image compressor according to claim 1, wherein the predicted pixel value generation unit is configured of one-clock-cycle delay section configured to be supplied with data for one pixel from the input pixel value correction unit, and produce a one-clock-cycle delay.

5. The image compressor according to claim 1, wherein the predicted pixel value generation unit includes:
a multiple-clock-cycle delay section configured to delay the data supplied from the input pixel value correction unit by multiple-clock cycles to output past multiple pixel signals; and
a computation section configured to generate a predicted value by referring to past multiple pixel signals from the multiple-clock-cycle delay section, and by using a predetermined mathematical function.

6. The image compressor according to claim 1, wherein the predicted error coding unit includes:
a bit length detection section configured to detect predicted error group information indicating a group to which the magnitude of the predicted error belongs according to the predicted error input from the predicted error computation unit, output the detected predicted error group information to a variable length code table, detect the number of added bits thereof, detect a bit reduction number by which the number of bits of the added bit data is to be reduced according to the target code amount difference level input from the target code amount difference level detection unit via a one-clock-cycle delay section with respect to the predicted error group in which the magnitude of the predicted error is equal to or larger than the predetermined value, and output to the one-clock-cycle delay section a total code length obtained by subtracting the bit reduction number from the sum of a variable length code length received from the variable length code table and the number of bits of the added bit data;
the variable length code table configured to output to a selector a variable length code length and a variable length code corresponding to the predicted error group information received from the bit length detection section, and output the variable length code length to the bit length detection section; and
the selector which selects the variable length code received from the variable length code table and the added bit data on the basis of the variable length code received from the variable length code table and the predicted error group information received from the bit length detection section, and outputs the selected variable length code and added bit data as continuous data.

7. The image compressor according to claim 1, wherein the packing unit outputs output data from the predicted error coding unit in a bit number unit twice or more than twice a set average code amount (a code amount per pixel), and the target code amount difference level detection unit performs difference computations between the set average code amount and a code amount output from the packing unit, and a cumulative computation of results of the difference computations, by one adder.

8. The image compressor according to claim 1, wherein the target code amount difference level detection unit includes:
an adder which adds together a set average code amount (a code amount per pixel) and target code amount difference information (a code amount difference cumulative addition result) held in a one-clock-cycle delay section one clock cycle before, subtracts the number of output bits (32) from the result of the addition when information on the number of output bytes (4-byte output signal) from the packing unit is valid, and outputs the code amount difference cumulative addition result as the target code amount difference information via the one-clock-cycle delay section; and
a quantization section configured to be supplied with the target code amount difference information output from the one-clock-cycle delay section and to perform quantization according to the target code amount difference information to output a target code amount difference level.

9. The image compressor according to claim 1, wherein the target code amount difference level detection unit determines a target code amount difference level by performing non-linear quantization on a cumulative computation result of differences between a set average code amount and a code amount output from the packing unit.

10. An image expander comprising:
an encoded data taking-in unit configured to take in variable-length-encoded data encoded with group information indicating a group to which the magnitude of a predicted code belongs and added bit data indicating the value of the predicted error, lower significant bit data in the added bit data being removed from an object to be encoded according to the level of a difference between a target code amount and a generated code amount at the time of encoding;
a target code amount difference level detection unit configured to detect a target code amount difference level indicating the magnitude of an excess by which a code amount consumed for a certain number of decoded pixels exceeds a target code amount corresponding to the number of pixels;
a predicted error decoding unit configured to decode, from variable-length-encoded data output from the encoded data taking-in unit, group information indicating a group to which the magnitude of a predicted error belongs and added bit data indicating a particular predicted error value in the group, thereby reproduce the predicted error, and perform reproduction by setting less significant bit data in the added bit data for the reproduced predicted error to 0 according to the target code amount difference level when the magnitude of the predicted error is equal to or larger than a predetermined value;
a predicted pixel value generation unit configured to generate a predicted pixel value by referring to a past reproduced pixel; and
a pixel value reproduction unit configured to reproduce a pixel value by adding the reproduced predicted error to the predicted pixel value.

11. The image expander according to claim 10, wherein the predicted error decoding unit has a storage section in which one-pixel-preceding predicted error group information indicating a group to which the magnitude of a predicted error one pixel before belongs is stored, and changes, according to the one-pixel-preceding predicted error group information, a variable length code decoding table containing the group information indicating the groups to which the magnitudes of the predicted errors belong.

12. The image expander according to claim 10, wherein the encoded data taking-in unit takes in the variable-length-encoded data in a bit number unit twice or more than twice a set average code amount (a code amount per pixel), and the target code amount difference level detection unit performs difference computations between the set average code amount and a taking-in code amount by the encoded data taking-in unit, and a cumulative computation of results of the difference computations, by one adder.

13. The image expander according to claim 10, wherein the encoded data taking-in unit includes:
first and second selectors supplied with compression-coded data (4-byte data) and having the compression-coded data successively taken in first and second one-clock-cycle delay sections in each clock cycle in a time period when a 4-byte taking-in signal is valid, the data already taken in the first and second one-clock-cycle delay sections being held in a time period when the 4-byte taking-in signal is invalid;
a third selector which cues, at a one-pixel preceding stage, as one continuous sequence of data, a variable length code in the encoded data held in the first and second one-clock-cycle delay sections on the basis of information less than 32 bits in the result of cumulative addition of the number of bits of the variable length code decoded till the time two pixels before;
a fourth selector which is supplied with data output from the third selector, and which cues a variable length code of a next decoded pixel on the basis of the number of bits (the code length) of encoded data one pixel before from a variable length decoding table in the predicted error decoding unit; and
an adder which adds together code length data supplied from the variable length decoding table and less significant five bits in the cumulative addition result one clock cycle before held by a third one-clock-cycle delay section to output data formed of six bits including a carry bit to the third one-clock-cycle delay section.

14. The image expander according to claim 10, wherein the target code amount difference level detection unit determines a target code amount difference level by performing non-linear quantization on a cumulative computation result of differences between a set average code amount and a taking-in code amount by the encoded data taking-in unit.

15. The image expander according to claim 10, wherein the predicted error decoding unit includes:
a fourth one-clock-cycle delay section configured to delay, by one clock cycle, variable-length-encoded data output from the encoded data taking-in unit;
a decoding table which is supplied with variable-length-encoded data from the fourth one-clock-cycle delay section, and which decodes group information indicating a group to which the magnitude of a predicted error belongs and the code length thereof, reproduces the number of added bits for indicating a particular predicted error value in the group on the basis of the group information, reproduces, on the basis of the group information, a bit reduction number by which the number of added bits is to be reduced according to the target code amount difference level detected in the target code amount difference level detection unit, if the predicted error is equal to or larger than a predetermined value, and generates a total number of bits (code length) as a result of subtraction of the bit reduction number from the sum of the code length of the group information and the number of added bits; and
a fifth selector which performs code expansion processing on the basis of the code length of the group information obtained as a result of decoding with the decoding table, by removing the encoded data in the group information and extracting the added bit data having the number of added bits, substitutes zero for less significant bit data for the bit reduction number in the added bit data, and outputs the resulting data.

16. The image expander according to claim 10, wherein the target code amount difference level detection unit includes:
a fifth one-clock-cycle delay section configured to be supplied with a 4-byte taking-in signal generated in the encoded data taking-in unit during a time period other than a two-clock-cycle period for taking in initial data, delay the signal by one clock cycle, and supply the signal as a 4-byte decoded code amount to minus input end of an adder;
the adder which is supplied through its one input terminal with a set average code amount (a code amount per pixel), and which adds the input set average code amount to a cumulative addition result one clock cycle before held by a sixth one-clock-cycle delay section, subtracts a code amount of 32 bits (4 bytes) from the result of cumulative addition of the set average code amount each time one-bit signal indicating the 4-byte form is input from the fifth one-clock-cycle delay section, and outputs the result of the subtraction as target code amount difference information via the sixth one-clock-cycle delay section; and
a quantization section which is supplied with the target code amount difference information output from the sixth one-clock-cycle delay section, and which performs the same predetermined quantization as that on the encoder side on the target code amount difference information and outputs the result of quantization as a target code amount difference level.

17. The image expander according to claim 10, wherein the predicted pixel value generation unit obtains, as the predicted pixel value, a signal produced by one-clock-cycle-delaying by means of a one-clock-cycle delay section the pixel value reproduced by the pixel value reproduction unit.

18. The image expander according to claim 10, wherein the predicted pixel value generation unit includes a multiple-clock-cycle delay section configured to delay the pixel value reproduced by the pixel value reproduction unit by multiple-clock cycles to output past multiple pixel signals; and
a computation section configured to generate a predicted value by referring to past multiple pixel signals from the multiple-clock-cycle delay section and by using a predetermined mathematical function

19. An image processing apparatus comprising:
an image compression processing unit having the image compressor according to claim 1;
an image expansion processing unit having the image expander according to claim 10;
an external memory; and
an image processing unit configured to temporarily store results of intermediate processing on input image data in the external memory via the image compression processing unit, and read out a plurality of intermediate processing results stored in the external memory via the image expansion processing unit to output final results of image processing.
